(19) United States
(12) Patent Application Publication
(10) Pub. No.: US 2007/0143132 A1
(43) Pub. Date: Jun. 21, 2007

(54) AUTOMATED VALUATION OF A PLURALITY OF PROPERTIES

(76) Inventors: Mark R. Linne, Bailey, CO (US); Martin S. Kane, Castle Rock, CO (US)

Correspondence Address: COCHRAN FREUND & YOUNG LLC, 2026 CARIBOU DR, SUITE 201, FORT COLLINS, CO, 80525, US

(21) Appl. No.: 11/611,694

(22) Filed: Dec. 15, 2006

Related U.S. Application Data
(60) Provisional application No. 60/751,010, filed on Dec. 16, 2005.

(51) Int. Cl. G06Q 99/00

(52) U.S. Cl. 705/1

(57) ABSTRACT

Disclosed are various embodiments of a system and method for valuing a plurality of properties. Assessor data is obtained that indicates a designated subdivision and various criteria for each of the properties. Assessor data is placed into a standard format to create a master data file. Modeling techniques are then used to separate and aggregate properties into modeling areas. Modeling areas are then used to calculate a predicted value for the properties. The predicted values are compared with actual sales values to create sales ratio data. If the deviation of the sales ratio data exceeds a certain amount, the master data file data is analyzed and modified until sales ratio data is achieved that falls within an acceptable deviation.

### CROSS-REFERENCE TO RELATED APPLICATIONS

This application is based upon and claims priority to U.S. provisional application Ser. No. 60/751,010, filed Dec. 16, 2005, entitled “Valuing of a Plurality of Properties,” and that application is specifically incorporated herein by reference for all it discloses and teaches.

### BACKGROUND OF THE INVENTION

Private sector automated valuation methods for real estate have existed for the past several years. Existing valuation tools have, however, been unreliable in providing accurate valuations. Numerous problems exist in attempting to provide automated valuations of real estate based upon the complexities and unique nature of residential real estate which has contributed to the lack of reliability in providing automated real estate valuations. This lack of reliability in providing accurate valuations has necessitated a unique appraisal based approach to automated valuation of real estate.

### SUMMARY OF THE INVENTION

The present invention overcomes the disadvantages and limitations of the prior art by providing a method of valuing a plurality of properties comprising: obtaining assessor data to compile a master data record, the assessor data comprising subdivision designations for the properties and a list of criteria comprising square footage, attributes, and assessed values for the properties; building modeling areas from the master data record by separating properties that are in a single assessor designated subdivision and have criteria with deviations greater than predetermined values, aggregating the properties that have deviations less than the predetermined values into new subdivisions, generating median statistics of the criteria for the properties in the subdivisions, rank ordering the subdivisions based on the median statistics so that the subdivisions have a rank order number and determining the location of each subdivision; clustering the subdivisions by plotting the location of the subdivisions on a map, labeling the subdivisions on the map with the rank order number and number of recent sales, combining subdivisions in proximate locations that have a ranking order number that is similar to create a modeling area that has at least a predetermined number of the recent sales; valuing the properties by generating a predicted value for the properties, comparing the predicted value with actual sales data to create sales ratio data, analyzing and sorting the master data record for properties in the modeling area if the sales ratio data has deviations that are greater than a predetermined value, and repeating the process of valuing the properties and generating the sales ratio data until the deviations are less than the predetermined value.

The present invention may further comprise program code for use in valuing a plurality of properties that provides interaction with a human user to perform the functions comprising: obtaining assessor data to compile a master data record, the assessor data comprising subdivision designations for the properties and a list of criteria comprising square footage, attributes and assessed values for the properties; building modeling areas from the master data record by separating properties that are in a single assessor designated subdivision and have criteria with deviations greater than predetermined values, aggregating the properties that have deviations less than the predetermined values into new subdivisions, generating median statistics of the criteria for the properties in the subdivisions, rank ordering the subdivisions based on the median statistics so that the subdivisions have a rank order number and determining the location of each subdivision; clustering the subdivisions by plotting the location of the subdivisions on a map, labeling the subdivisions on the map with the rank order number and number of recent sales, combining subdivisions in proximate locations that have a ranking order number that is similar to create a modeling area that has at least a predetermined number of the recent sales; valuing the properties by generating a predicted value for the properties, comparing the predicted value with actual sales data to create sales ratio data, analyzing and sorting the master data record for properties in the modeling area if the sales ratio data has deviations that are greater than a predetermined value, and repeating the process of valuing the properties and generating the sales ratio data until the deviations are less than the predetermined value.

The present invention may further comprise a computer system for valuing a plurality of properties using assessor data comprising: a first input that reads the assessor data comprising subdivision designations for the properties and a list of criteria comprising square footage, attributes and assessed values for the properties; a storage device for storing the assessor data and computer program code; a second input that allows a user to interact the computer program code; a processor that performs the functions comprising: compiling a master data record from the assessor data comprising subdivision designations for the properties and a list of criteria comprising square footage, attributes and assessed values for the properties; obtaining assessor data to compile a master data record, the assessor data comprising subdivision designations for the properties and a list of criteria comprising square footage, attributes and assessed values for the properties; building modeling areas from the master data record by separating properties that are in a single assessor designated subdivision and have criteria with deviations greater than predetermined values, aggregating the properties that have deviations less than the predetermined values into new subdivisions, generating median statistics of the criteria for the properties in the subdivisions, rank ordering the subdivisions based on the median statistics so that the subdivisions have a rank order number and determining the location of each subdivision; clustering the subdivisions by plotting the location of the subdivisions on a map, labeling the subdivisions on the map with the rank order number and number of recent sales, combining subdivisions in proximate locations that have a ranking order number that is similar to create a modeling area that has at least a predetermined number of the recent sales; valuing the properties by generating a predicted value for the properties, comparing the predicted value with actual sales data to create sales ratio data, analyzing and sorting the master data record for properties in the modeling area if the sales ratio data has deviations that are greater than a predetermined value, and repeating the process of valuing the properties and generating the sales ratio data until the deviations are less than the predetermined value.

### BRIEF DESCRIPTION OF THE DRAWINGS

In the drawings,

FIG. 1 is a flow diagram illustrating the manner in which a master data file is created.

FIG. 2 is a block diagram illustrating the process of building modeling areas.

FIG. 3 is a block diagram illustrating the process of developing subdivision statistics.

FIG. 4 is a block diagram illustrating the process of clustering subdivisions.

FIG. 5 is a block diagram illustrating the process of valuing homes using modeling areas.

FIG. 6 is an illustration of a computer system that interacts with the program code to value a plurality of properties.

### DETAILED DESCRIPTION OF THE INVENTION

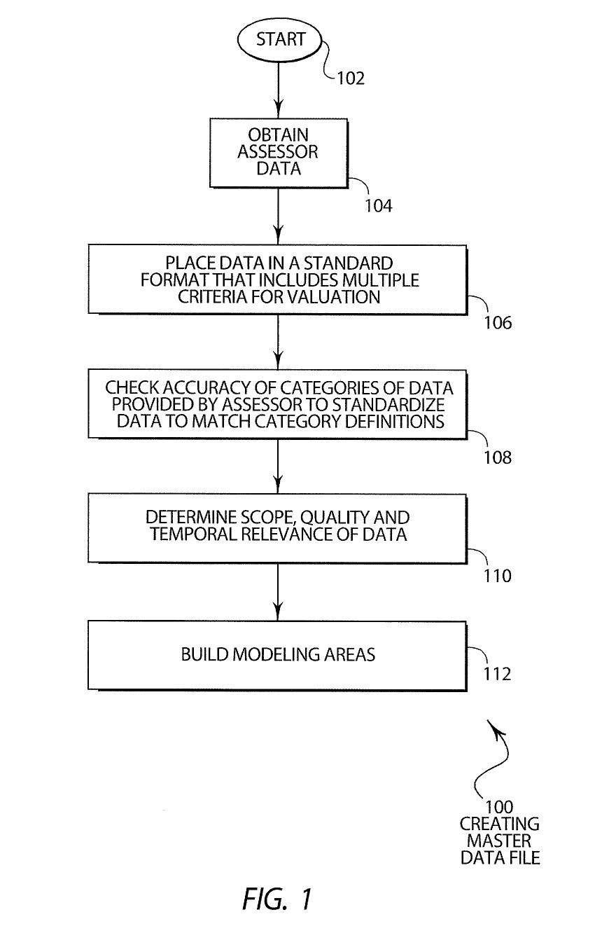

FIG. 1 discloses the process for creating a master data file 100. The process starts at step 102 and proceeds to step 104 where the assessor data is obtained. In many states, county assessors collect and store the relevant data. In some areas, a single county will cover an entire city such as Las Vegas, Nev. or Phoenix, Ariz. In other areas, such as Denver, Colo., there are multiple counties that cover the city, and there are separate assessors' offices for each county that collect the data. The detail and form of the data may vary significantly from county to county. By law, in almost all jurisdictions, the assessor is required to specifically assess the land separately from the improvements on the land. Hence, almost all assessor data has separate land values and improvement values. Some data is very complete and includes GIS information, as well as detailed data regarding square footage, number of bedrooms and bathrooms, number of fireplaces, pools, garage size, basement size, etc. Other assessor data from some counties are less complete or may have different emphasis. For example, fireplaces may be an important feature in Denver and the surrounding mountain area, while they are less important in Phoenix. Further, swimming pools may be more an important feature in Phoenix than they are in the Denver area, and are valuated differently. Further, definitions of certain items may vary from assessor's office to assessor's office. For example, a “family room” may be defined differently from jurisdiction to jurisdiction. In addition, the requirements of what constitutes a “bedroom” may be different in various jurisdictions. A “bedroom” in one jurisdiction may require an escape window, a closest and/or must be above grade, whereas in another jurisdiction one or more of those criteria may not be required.

The manner in which the data is obtained from the assessor's office is different also. Some assessors provide data over the Internet which can be easily downloaded in a format that can be easily accessed. On the other hand, data such as data available from the City and County of Denver Assessor's Office is only available from a mainframe computer. The data is in a format that is difficult to read and access.

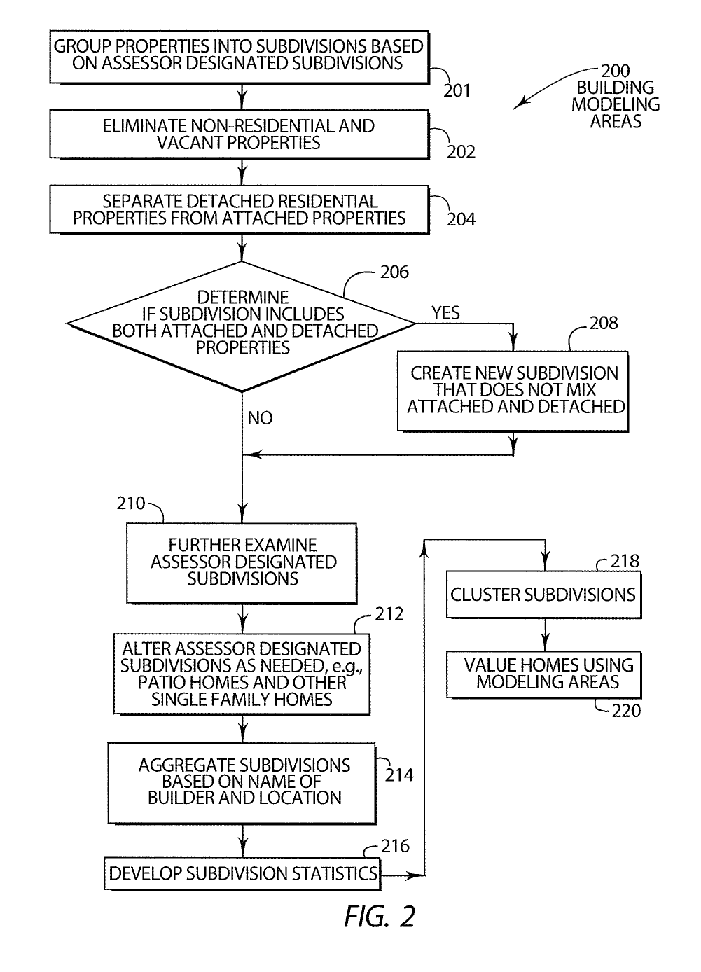

At step 106, the data is then placed in a standard format to create a master data file that includes multiple criteria for valuation. For example, the data record may be placed in a format similar to a spreadsheet in which each line represents a different property, and there are separate columns indicating the value of the improvements, the value of the land and other data such as the number of bedrooms, total square footage, above-grade square footage, number of bathrooms, fireplaces, swimming pools, type of siding, etc. The data from some assessors' offices is provided in such a standard format, such as described above, which minimizes the amount of work at step 106. Other assessors' offices may provide data in several different formats, so that the data must be standardized to a single standardized format. Included in the formatting are places for variables that indicate attributes such as swimming pools, fireplaces, etc. When standardizing the data, a common set of definitions must be used to ensure that the data is correct. Hence, the definitions used by the assessor's office must be examined to see if these definitions match the definitions of the standardized data, as set forth in step 108. The process then proceeds to step 110 where the data is examined to determine the scope, quality and temporal relevance of the data. Data from the various assessors' offices have different strengths and weaknesses. For example, some data is updated on a weekly or daily basis, whereas other data may not be updated for months. Some data, as pointed out above, will include precise definitions for various attributes, whereas other data may have only general broad definitions. In a fast moving market, recent sales are critical to determine the rate of appreciation/depreciation. If data is only updated on an infrequent basis by the assessor's office, the data will be weak. The processes that are performed in step 110 identify these strengths and weaknesses of the data. The process then proceeds to step 112 which is the building of the modeling areas. The building of the modeling areas is described more fully with respect to the description of FIG. 2.

FIG. 2 is a flow diagram 200 illustrating the process of building modeling areas. At step 201, the assessor's data is used to group the properties into the subdivisions indicated by the assessor's data. The assessor's office normally provides a description of the particular subdivision for each property in which the property is located. The subdivision data is included in the data that is provided by the assessor's office. As disclosed in FIG. 2, non-residential and vacant properties, i.e., unimproved land and commercial properties, are eliminated from the master data file at step 202. Usually the assessor data has a variable in the data that indicates the type of improvement, i.e., dwelling, on the property. For example, various types of commercial properties will have certain variables, whereas duplexes, triplexes, quadraplexes, apartment buildings, condominiums, etc. each have their own variable to indicate the type of dwelling. All of the non-residential properties are eliminated from the database in step 202 by sorting on this field, which may include apartment buildings and commercial properties. When considering certain multiple family dwellings, each unit is considered as a separate piece of property. Hence, each condominium is considered a separate property. On the other hand, duplexes, triplexes and quadplexes are generally targeted as single properties. Apartment buildings are eliminated unless they are condominiums.

The process then proceeds to step 204 where the detached residential properties and the attached residential properties are separated. This sorting step is also performed by investigating the variable that indicates the type of property. In other words, a variable indicating a duplex and another variable indicating a triplex would be sorted for inclusion in the attached properties, whereas variables indicating a single-family home would be sorted into the detached properties. At step 206, it is determined whether each of the subdivisions includes both attached and detached properties. In other words, the data is sorted by subdivisions and by the variable indicating attached and detached properties to determine if there are subdivisions that include both attached and detached properties. The reason why the detached properties are separated from the attached properties is that they generally value differently. As a result, the detached properties should not be mixed in with the attached properties. Sometimes, counties mix these properties in a single subdivision. If it is determined that some of the subdivisions include both attached and detached properties, the process proceeds to step 208. At step 208, two separate subdivisions are created from the single subdivision, i.e., one subdivision that includes detached properties and another subdivision that includes attached properties. The process then proceeds to step 210. If it is determined at step 206 that there is not a mixture of detached and attached properties in a single subdivision, the process proceeds directly to step 210.

The process then proceeds to step 210 where the assessor-designated neighborhoods are further examined. For example, the number of properties in each subdivision is determined. Some subdivisions may have 500 to 1,000 properties, whereas others may have only one or two properties. For example, in metropolitan Las Vegas, the assessor's office had created about 5,000 subdivisions in which there was only one property per subdivision (straggler subdivisions). In the larger subdivisions, there is a risk that there are not a consistent set of properties in the subdivision that will value similarly. The process then proceeds to step 212 in which the modeler alters the assessor-designated subdivisions as needed. For example, the straggler subdivisions that include only one or just several properties may be combined with an existing subdivision to minimize the number of subdivisions that must be analyzed. In addition, even though detached properties were previously separated from attached properties at step 204, other properties may have been designated in a subdivision that value differently. For example, patio homes may have been designated by the assessor in the same subdivision with more expensive single-family homes. The modeler may then decide to separate the patio homes as a separate subdivision.

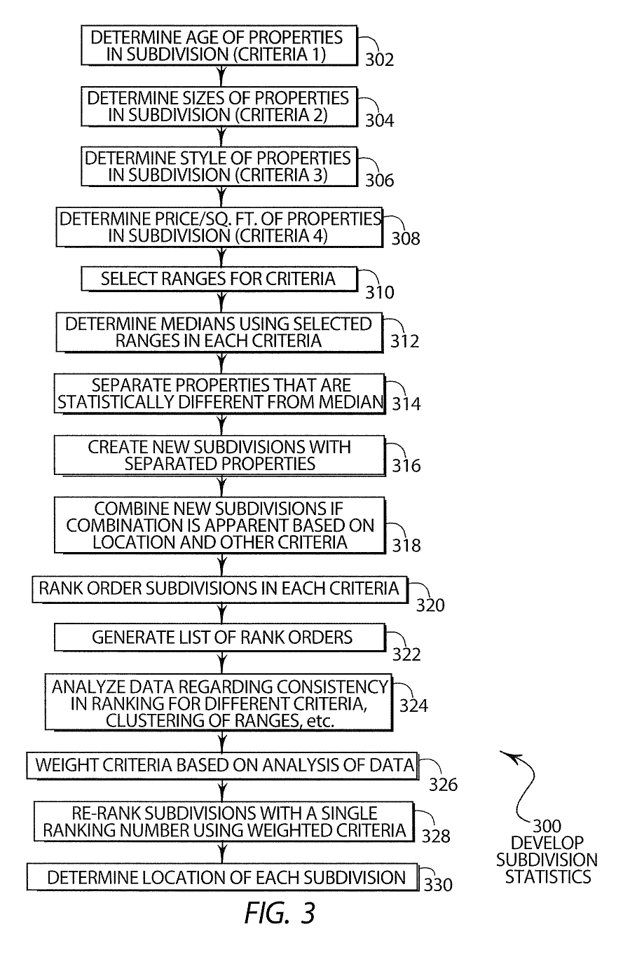

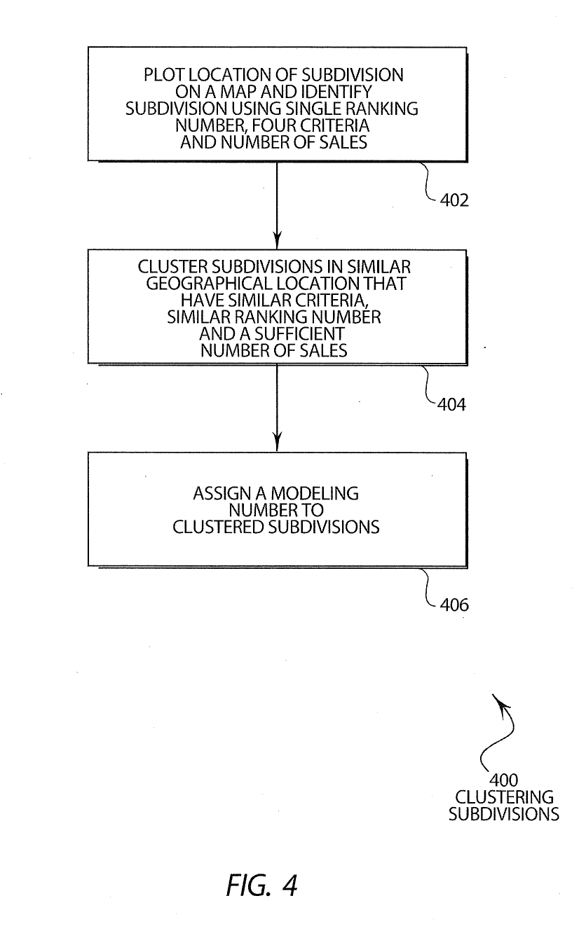

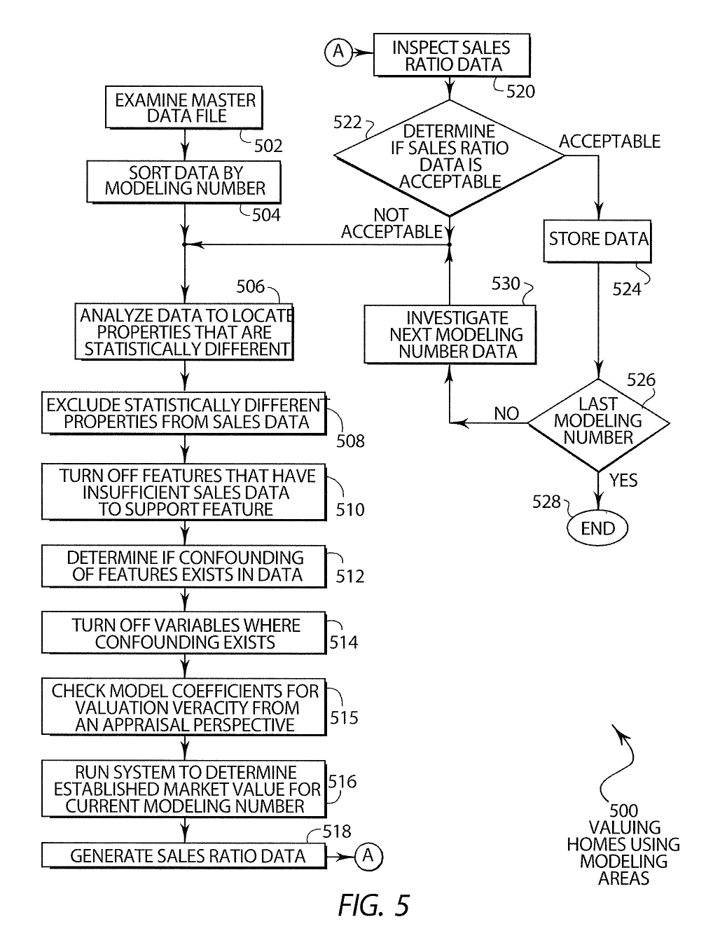

The process of FIG. 2 then proceeds to step 214. At step 214, the modeler may wish to aggregate certain subdivisions based upon the name of the builder and the location of the subdivisions. For example, XYZ builder may have developed and built the Fossil Creek Subdivision's filings 1 through 9 in Fort Collins, Colo. Although these nine subdivision filings are separate subdivisions, the properties are substantially the same and are in the same area. Hence, these nine subdivisions can be combined into a single subdivision. At step 216, one embodiment for developing subdivision statistics is disclosed. This is explained in more detail with regard to the description of FIG. 3. At step 218, the subdivisions are clustered. One embodiment of a process for clustering subdivisions in accordance with step 218 is disclosed in more detail with respect to the disclosure of FIG. 4. The process then proceeds to step 220 in which the properties are valued using the modeling areas. One embodiment for valuing homes using modeling areas is disclosed in more detail with respect to the description of FIG. 5.

FIG. 3 is a flow diagram 300 illustrating one embodiment of a process for developing subdivision statistics. As shown in FIG. 3, the process starts at step 302. At step 302, the age of the properties in the subdivision is determined based upon the assessor data, which may include the date of an occupancy permit or the filing of a building permit. The age of the property is referred to as criteria number 1. The process then proceeds to step 304 in which the size of the properties are determined in the subdivision. Again, the sizes of the properties are the recorded square footage in the assessor's data. The size of the property is referred to as criteria number 2. The process then proceeds to step 306 in which the style of the properties in the subdivision is determined. Styles may comprise one-story ranch, split-level, two-story, etc. Style is referred to as criteria number 3. The process then proceeds to step 308 in which the price per square foot of the property is determined. The price per square foot is based either on the most recent sales of houses in that subdivision or the assessor's values per square foot. The price per square foot is referred to as criteria number 4. The process then proceeds to step 310 where ranges for the criteria are selected. For example, an age range of just several years may be selected. The range for the size of properties in the subdivision may vary in accordance with the size of the houses in the subdivision. The range and number of categories depends on the distribution of data and the targeted number of models for a given market.

After the ranges for each of the criteria, except for criteria number 3, are selected, the medians for the properties are calculated using the selected ranges in accordance with step 312. The process then proceeds to step 314 in which the properties that are statistically different from the median are separated and not used in the statistical analysis. For example, houses that differ by one sigma or two sigma in any one criteria may be removed for the purpose of statistical analysis. At step 316, new subdivisions are created with the properties that have been separated at step 314. At step 318, the new subdivisions that were created in step 316 are combined if it is apparent how to combine these new subdivisions based on the location and other criteria determined for these properties. For example, in the Montclair Subdivision in Denver, most blocks contain the original homestead house which is a large, old Victorian house that has usually been restored. The other houses on the block are fill-in houses that are typically one-story brick ranches that were built in the fifties and sixties that have about 1,500 square feet. Obviously, the homestead house will be valued differently from the fill-in houses. A new subdivision can be created for these larger, older Victorian houses at step 316. Each of these subdivisions which contains one house can then be combined to form one subdivision because they are located in a single area, i.e., Montclair in Denver, and have a similar size and age.

The next step in the process in developing subdivision statistics in accordance with FIG. 3 is to rank order the subdivisions for each criteria as set forth in step 320. In other words, if there are 500 subdivisions in a metropolitan area that are being analyzed, each subdivision will be given a ranking number for criteria numbers 1, 2 and 4. For example, a subdivision that has the lowest median price per square foot will have a ranking order of number 1. The subdivision having the highest value per square foot would be given a ranking number of 500. Similarly, the subdivision that has the oldest median age of properties will be given the ranking order of 1 for criteria number 1. The subdivisions that have the smallest median size will be given a ranking order of 1 for criteria number 2. At step 322, lists are generated of the rank orders of the subdivisions. In addition, criteria number 3 will also be included in the list of rank orders for each subdivision. The process then proceeds to step 324. At step 324, the data provided in the list of rank orders is analyzed with respect to consistency in ranking for the different criteria. The data is also analyzed to determine if there is a clustering within the ranges that have been set for each of the criteria. Typically, the data is spread according to a bell curve with the most occurrences at the center of the curve. For example, the price per square footage data may have a center of the bell curve within the range of $100 per square foot to $120 per square foot. The tails of the bell curve, i.e., the higher prices per square foot and the lower prices per square foot, have fewer occurrences. Hence, the ranges at the center of the bell curve must be narrower than the ranges at the tails of the bell curve. These ranges can be reset after the distribution of data is determined. The data can be also analyzed with respect to other statistical techniques.

The process of FIG. 3 then proceeds to step 326. At step 326, the various criteria are weighted based upon the analysis of the data. If a subdivision has a fairly consistent ranking for each of the criteria, weighting of individual criteria is not necessary. However, if one of the criteria shows a different ranking than the other criteria, it may be desirable to weight one of these criteria to establish a more effective ranking. In addition, if the data seems to be compressed, it may be desirable to weight other data to achieve proper ranking. For example, if half of the subdivisions in a metropolitan area reflect a price of from $100 to $110 per square foot, it may be desirable to weight another factor such as criteria number 3 (style of the properties) or criteria number 1 (age of the properties) for achieving proper ranking of the subdivisions. The process of FIG. 3 then proceeds to step 328 in which the subdivisions are re-ranked with a single ranking number using the weighted criteria established in step 326. At step 330, the geographical center of each subdivision is located and recorded in the database. This data can comprise a GPS coordinate or an actual address location.

FIG. 4 discloses the process 400 of clustering subdivisions. At step 402, the location of the subdivision is plotted on a map. This can be done using automated plotting techniques or can be drawn by hand. Each of the subdivisions may be identified using the single ranking number, the ranking in accordance with the four criteria and the number of sales that have occurred over a most recent period of time in that subdivision. For example, sales over the past year may be displayed for each of the subdivisions. In markets that are appreciating quickly, it may be desirable to use a different period of time, such as the sales that have occurred over the past six months. The plotting of the subdivisions on a map provides a visual analysis of the rankings of the subdivisions based upon their geographical location. In addition, it provides a visual method of viewing geographical features with respect to the location of the subdivisions to determine how such geographical features may affect the price of homes in the subdivision. For example, a high power line may run right through the middle of a subdivision and adversely affect the prices in that subdivision. Alternatively, another subdivision may be located around a lake which enhances the values in that subdivision. The location of railroad tracks, power lines, lakes and views are important factors in building the data model.

In the process of FIG. 4 then proceeds to step 404 in which subdivisions in similar geographical locations that have similar criteria, similar ranking number and a sufficient number of sales are clustered together considering the various geographical features that are identified from the plotted map. The ranking order number that is developed in accordance with the description of FIG. 3, as well as the other statistics, are illustrated on the map as described above with respect to step 402. Subdivisions can be divided into multiple groups arrayed from the smallest, oldest and worst properties to the nicest, largest and best properties. Based on empirical market data, models typically include 2,000 to 3,000 properties. Once subdivisions are stratified, they can be grouped by strata. The next step is to plot all of the subdivisions in group 1 on a map. The subdivisions in group 1 that are in the same proximate location can then be combined to form a modeling area. Similar steps can be taken for groups 2 through 10. It is important in the step of clustering subdivisions that the subdivisions be located in the same geographical area. In addition, it is desirable to have subdivisions clustered together that have a sufficient number of sales in order to perform a predictive sales analysis for each model group. It is desirable to have a minimum of 50 sales in each modeling area. For example, if several subdivisions have similar rankings, criteria and CDU numbers, and they are in the same approximate area, and some of the subdivisions do not have a sufficient number of sales, it is beneficial to combine these subdivisions to obtain a sufficient number of sales statistics for the predictive models of all the subdivisions that have been clustered together in a single model. After the subdivisions have been clustered at step 404, the process proceeds to step 406. At step 406, the clustered subdivisions are assigned a modeling number to identify the clustered subdivisions. It is important to determine the optimum number of modeling areas in a market. Since it takes a certain amount of time to calculate the price of each property in each modeling area, the greater the number of modeling areas, the longer it will take to run the predictive values. Hence, there is a tradeoff between making the modeling areas as small as possible, but making them large enough so that predictive models can be run in a reasonable time period.

FIG. 5 discloses the process 500 of valuing homes using the modeling areas. At step 502, the master data file is examined. The master data file is a listing of each property that includes all of the data associated with that property, together with a modeling number. The data is examined to ensure that each property has a modeling number and includes the relevant data. At step 504, the master data file is sorted by the modeling number. For example, all of the properties falling into modeling area number 1 are listed at the top of the data file. At step 506, the actual sales data is analyzed in each of the modeling areas. For example, sales data may be graphed and placed in tables to view the sales data in each modeling area over time. It can then be determined if the sales are going up, flat or going down during the relevant time period. The statistically different properties can also be identified by analyzing this data. At step 508, the statistically different properties are excluded from the sales data, and these properties may be moved to a different model area. An example of such a statistically different property may be an 8,000 square foot French chalet farmhouse that was the original homestead house in Harvey Park, Denver and is surrounded by 1,200 square foot blonde brick ranch houses built in the late fifties and early sixties. If these statistically different properties were not identified earlier in the process of generating modeling areas, they will be identified and excluded from the sales data at steps 506 and 508.

At step 510, of FIG. 5, features that are listed for properties that have insufficient sales data to support the feature can be turned off. For example, if there are very few sales of properties with fireplaces, there is an insufficient amount of data to value the addition of a fireplace. The modeler can then access the data and turn off the variable for fireplaces so that the data model is not affected. The process then proceeds to step 512 where it is determined if confounding of features exists in the data. For example, a modeling area can be examined that has 50 sales of which 30 sales included two bathrooms and 20 sales included three bathrooms. If it is determined that 30 homes are two-story and 20 homes are ranches, the two-story feature could confound the three bathroom feature. In other words, if additional weight is given to both the two-story feature and the three bathroom feature, confounding occurs and the predictive model is skewed. Hence, the additional bathroom may be eliminated from the data since it is confounding the results and masking influence of another variable. Other features may also provide masking. For example, it may be determined that fireplaces add significant value to properties in certain locations. However, the properties that include fireplaces may also include a brick exterior that is not included on the properties that do not have a fireplace. Similarly, the builder may have decided to include fireplaces with all homes that have swimming pools in the subdivision. Since these two variables measure the same value, a negative value may result for one of these variables which would not make appraisal sense. In such a case, one of the variables, such as the fireplace, would be removed. The step of removing these variables is set forth in step 514.

Since the valuation model is appraisal based, coefficients are evaluated whenever the model is run to determine if the coefficients make sense in terms of direction and magnitude in step 515. This evaluation supersedes any positive statistical outcome. For example, a model with a negative value per square foot of living area would be rejected, even with excellent outcome stats, since it does not make practical sense that larger homes would be valued less than smaller homes in a given modeling area. An additional veracity check may include, for example, that a $25,000 coefficient value for a fireplace may make sense in a modeling area with an average sale price of $1,000,000, but not in a modeling area that averages $100,000.

As set forth in FIG. 5, the process then proceeds to step 516 in which the valuing system is run to determine the sales price for each modeling number starting with the first modeling number. The values are then calculated for the first modeling number and stored for each property. At step 518, the sales ratio data is generated. The sales ratio data is the predicted price of each house divided by the actual sales price for that house. Only sales prices used in the modeling process are used to generate the sales ratio data. The valuing model looks at the average price per square foot in the modeling area and adds and subtracts features to predict the value of each property. In this way, the actual sales price can be compared to the predicted price to determine the accuracy of the model. The process then proceeds to step 520 where the sales ratio data is inspected by the modeler. At step 522, it is determined whether or not the sales ratio data is acceptable. If the data is not acceptable, the process returns to step 506 where the data is further analyzed. If the sales ratio data is acceptable, the process proceeds to step 524 where the sales data is stored for each of the properties. At step 526, it is determined if all of the modeling numbers have been analyzed. If so, the process ends at step 528. If all the modeling numbers have not been analyzed, the process proceeds to step 530 to investigate the next modeling number set of data. The process then proceeds to step 506 to analyze the next modeling data.

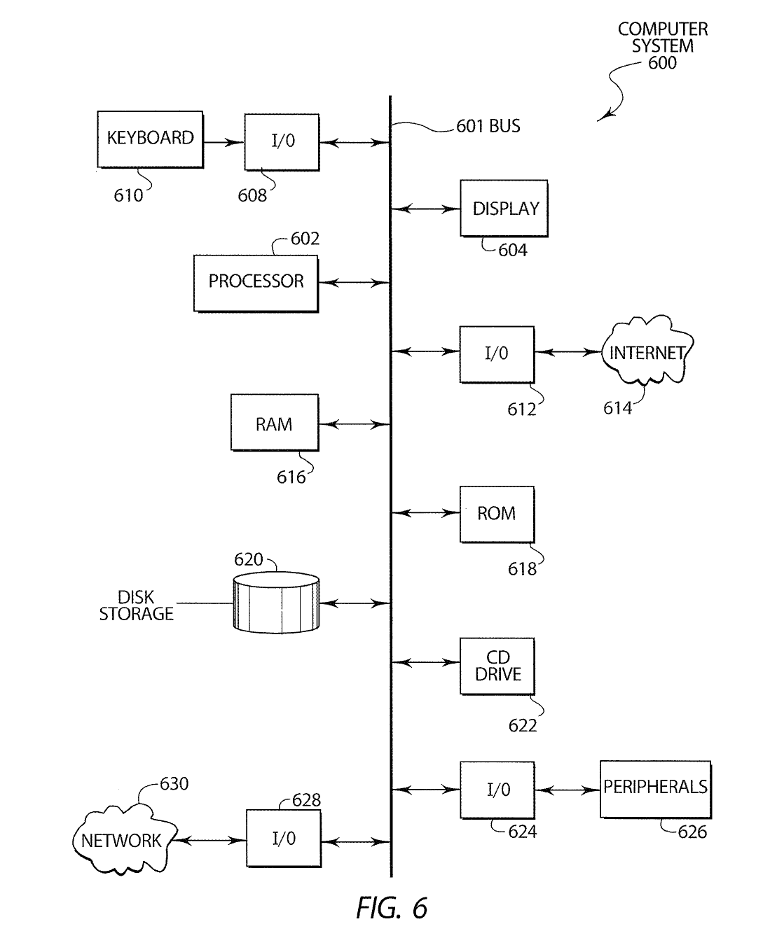

FIG. 6 is an illustration of a computer system 600 that interacts with the program code to value a plurality of properties. A bus 601 provides a way of interconnecting the various parts of the computer system 600. Processor 602 can comprise any desired processor including micro-processors such as RISC processors, CISC processors, etc. The processor sends and receives data over the bus 601 and processes the data in accordance with the instructions provided by the program code. Display 604 is also connected to the bus 601 and displays information in accordance with the computer program. I/O device 608 is connected to a keyboard 610 which allows a user to input manual commands and data. I/O device 612 interfaces with Internet 614 and provides a communications link to Internet 614. Data that is necessary to operate the computer program can be downloaded from the Internet 614. RAM 616 and RAM 618 allow data and program instructions to be provided to the processor 602 in a rapid fashion. Disk storage 620 stores the program code and various data needed to operate the program code. CD drive 622 provides an input to the computer system 600 for loading the computer program code and data. I/O device 624 is connected to various peripherals 626 such as printers, copiers, fax devices, etc. I/O device 628 is connected to a network 630 to provide another communications channel for the computer system 600.

Hence, the embodiments disclosed herein set forth a unique system that is capable of obtaining assessor data and placing that data in a standardized format, building modeling areas, developing subdivision statistics, clustering subdivisions and valuing homes using a self-checking system that compares the predicted value of a property against actual sales prices. The feedback loops allow the modeler to alter and vary the model and features within the model to obtain a highly accurate set of data.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of valuing a plurality of properties comprising:
obtaining assessor data to compile a master data record, said assessor data comprising subdivision designations for said properties and a list of criteria comprising square footage, attributes and assessed values for said properties;
building modeling areas from said master data record by separating properties that are in a single assessor designated subdivision and have criteria with deviations greater than predetermined values, aggregating said properties that have deviations less than said predetermined values into new subdivisions, generating median statistics of said criteria for said properties in said subdivisions, rank ordering said subdivisions based on said median statistics so that said subdivisions have a rank order number and determining the location of each subdivision;
clustering said subdivisions by plotting said location of said subdivisions on a map, labeling said subdivisions on said map with said rank order number and number of recent sales, combining subdivisions in proximate locations that have a ranking order number that is similar to create a modeling area that has at least a predetermined number of said recent sales; and
valuing said properties by generating a predicted value for said properties, comparing said predicted value with actual sales data to create sales ratio data, analyzing and sorting said master data record for properties in said modeling area if said sales ratio data has deviations that are greater than a predetermined value, and repeating said process of valuing said properties and generating said sales ratio data until said deviations are less than said predetermined value.

2. Program code for use in valuing a plurality of properties that provides interaction with a human user to perform the functions comprising:
obtaining assessor data to compile a master data record, said assessor data comprising subdivision designations for said properties and a list of criteria comprising square footage, attributes and assessed values for said properties;
building modeling areas from said master data record by separating properties that are in a single assessor designated subdivision and have criteria with deviations greater than predetermined values, aggregating said properties that have deviations less than said predetermined values into new subdivisions, generating median statistics of said criteria for said properties in said subdivisions, rank ordering said subdivisions based on said median statistics so that said subdivisions have a rank order number and determining the location of each subdivision;
clustering said subdivisions by plotting said location of said subdivisions on a map, labeling said subdivisions on said map with said rank order number and number of recent sales, combining subdivisions in proximate locations that have a ranking order number that is similar to create a modeling area that has at least a predetermined number of said recent sales; and
valuing said properties by generating a predicted value for said properties, comparing said predicted value with actual sales data to create sales ratio data, analyzing and sorting said master data record for properties in said modeling area if said sales ratio data has deviations that are greater than a predetermined value, and repeating said process of valuing said properties and generating said sales ratio data until said deviations are less than said predetermined value.

3. A computer system for valuing a plurality of properties using assessor data comprising:
a first input that reads said assessor data comprising subdivision designations for said properties and a list of criteria comprising square footage, attributes and assessed values for said properties;
a storage device for storing said assessor data and computer program code;
a second input that allows a user to interact said computer program code;
a processor that performs the functions comprising:
compiling a master data record from said assessor data comprising subdivision designations for said properties and a list of criteria comprising square footage, attributes and assessed values for said properties;
obtaining assessor data to compile a master data record, said assessor data comprising subdivision designations for said properties and a list of criteria comprising square footage, attributes and assessed values for said properties;
building modeling areas from said master data record by separating properties that are in a single assessor designated subdivision and have criteria with deviations greater than predetermined values, aggregating said properties that have deviations less than said predetermined values into new subdivisions, generating median statistics of said criteria for said properties in said subdivisions, rank ordering said subdivisions based on said median statistics so that said subdivisions have a rank order number and determining the location of each subdivision;
clustering said subdivisions by plotting said location of said subdivisions on a map, labeling said subdivisions on said map with said rank order number and number of recent sales, combining subdivisions in proximate locations that have a ranking order number that is similar to create a modeling area that has at least a predetermined number of said recent sales; and
valuing said properties by generating a predicted value for said properties, comparing said predicted value with actual sales data to create sales ratio data, analyzing and sorting said master data record for properties in said modeling area if said sales ratio data has deviations that are greater than a predetermined value, and repeating said process of valuing said properties and generating said sales ratio data until said deviations are less than said predetermined value.
